(19) United States
(12) Patent Application Publication
(10) Pub. No.: US 2024/0136943 A1
(43) Pub. Date: Apr. 25, 2024

(54) POWER CONVERTER

(71) Applicant: HUAWEI TECHNOLOGIES CO., LTD., Shenzhen (CN)

(72) Inventor: Eduardo FACANHA DE OLIVEIRA, Nuremberg (DE)

(21) Appl. No.: 18/405,132

(22) Filed: Jan. 5, 2024

Related U.S. Application Data
(63) Continuation of application No. PCT/EP2021/069093, filed on Jul. 9, 2021.

(51) Int. Cl. H02M 7/483; H02M 1/00; H02M 1/44; H02M 7/5387

(52) U.S. Cl. CPC H02M 7/4835; H02M 1/0095; H02M 1/44; H02M 7/53871

(57) ABSTRACT

The present disclosure relates to a power converter (100, 200) comprising: an alternate current, AC, terminal (101) for providing an input phase voltage (Vᵢ(t)); a first direct current, DC, terminal (102) for providing a first DC voltage (V_{DC}) with reference to a third DC terminal (104); a second DC terminal (103) for providing a second DC voltage (V_{c2}) with reference to the third DC terminal (104); a first commutation path (110) between the AC terminal (101) and the second DC terminal (103); a second commutation path (120) between the AC terminal (101) and the first DC terminal (102); a third commutation path (130) between the AC terminal (101) and the second DC terminal (103); and a fourth commutation path (140) between the AC terminal (101) and the first DC terminal (102).

### CROSS-REFERENCE TO RELATED APPLICATIONS

This application is a continuation of International Application No. PCT/EP2021/069093, filed on Jul. 9, 2021, the disclosure of which is hereby incorporated by reference in its entirety.

### TECHNICAL FIELD

The present disclosure relates to a power converter and a method for power conversion. In particular, the disclosure relates to the field of circuit topology for AC/DC power converters and particularly to single-phase power factor correction (PFC) rectifiers for use in automotive on-board chargers (OBC) and other applications. Specifically, this disclosure relates to a 5-level hybrid PFC rectifier.

### BACKGROUND

Some applications, like automotive on-board chargers (OBC), demand compact and low weight power converters. Magnetic components are considered the bottleneck in high efficient and compact power electronics circuits, taking up 50% of volume and loss. There is a need to reduce the volume of such components in a single-phase power factor correction (PFC) rectifier.

With respect to the AC/DC stage, the most common way to reduce the volume of the magnetic components is increasing the switching frequency. However, increasing the switching frequency leads to an increase of both conduction and core losses and to higher EMC filter efforts, especially for switching frequencies higher than 150 kHz. Measuring the expected normalized EMC filter sizing over the switching frequency has shown that a discontinuity exists at 150 kHz, at which the main emission standards start their requirements. For this reason, the switching frequency needs to be increased to frequencies higher than 400 kHz in order to start achieving some benefit regarding size in comparison to 150 kHz.

### SUMMARY

It is the object of this disclosure to provide a circuitry for an AC/DC power converter, in particular for a single-phase power factor correction (PFC) rectifier, without the above described disadvantages.

In particular, it is the object of this disclosure to provide a compact and low weight power converter.

This object is achieved by the features of the independent claims. Further implementation forms are apparent from the dependent claims, the description and the figures.

A basic idea of this disclosure is the addition of two commutation paths to a common 3-level PFC rectifier. The addition of these commutation paths result in a novel 5-level PFC Rectifier, as shown in the FIGS. 1 and 2. For the implementation of those commutation paths, an additional switching circuit is required, comprising the diodes D₉ and D₁₁ as well as the switches S₁₀ and S₁₂. This additional switching circuit is then connected to a second DC-link capacitor C₂. Depending on the phase angle of the sine wave, the converter will select the one out of the available DC-links that best matches the required output voltage levels.

The disclosure describes a novel topology of associating a bridgeless dual-boost PFC rectifier with return diodes with an additional switching circuit connected to a second DC-link capacitor C₂, as shown in FIGS. 1 and 2, resulting in a novel 5-level PFC Rectifier. Voltage V_{c2} can assume any value between 0 and V_{dc}. The higher the value of V_{c2}, the higher the amount of power flowing to C₂. Full power will be transferred to C₂ if V_{c2} is equal or higher than the peak of the AC voltage. The lowest average ripple current through the AC chokes, and consequently the lowest required inductance, happens for V_{c2} equal to the half of V_{dc}.

Besides the reduction of the required AC filter inductance, the main advantages of a 5-level topology compared to 2 or 3-level circuits are the lower electrical stresses on the semiconductors, the better distribution of losses through the components and lower EMC efforts.

On the other hand, multilevel circuits have a higher amount of components. However, this doesn't mean larger semiconductor chip area, which are related to the amount of losses. Of course, it can be combined with the increase of the switching frequency in an appropriate manner to optimize the achievements.

Such topology improvement represents a most suitable way to reduce the volume of the magnetics, without the cost of increasing the losses due to the use of very high switching frequencies.

In order to describe the invention in detail, the following terms, abbreviations and notations will be used:

PFC Power Factor Correction DC direct current AC alternating current PWM Pulse Width Modulation PD Phase Disposition OBC On-board Charger EMI Electro-Magnetic Interference

In this disclosure, power converters are described. Power converters, also referred to as power electronics converters, are applied for converting electric energy from one form to another, such as converting between AC and DC or between DC and DC, e.g., between high or medium voltage DC and low voltage DC. Power converter can also change the voltage or frequency or some combination of these. Power electronics converter are based on power electronics switches that can be actively controlled by applying ON/OFF logic (i.e., PWM operation, usually commanded by a closed loop control algorithm).

In this disclosure, PFC (power factor correction) and PFC rectifiers are described. Power factor correction shapes the input current of off-line power supplies to maximize the real power available from the mains. Ideally, the electrical appliance should present a load that emulates a pure resistor, in which case the reactive power drawn by the device is zero. Inherent in this scenario is the absence of input current harmonics, i.e., the current is a perfect replica of the input voltage, usually a sine wave, and is exactly in phase with it. In this case the current drawn from the mains is at a minimum for the real power required to perform the needed work, and this minimizes losses and costs associated not only with the distribution of the power, but also with the generation of the power and the equipment involved in the process. Power factor correction is defined as the ratio of real power to apparent power, where the real power is the average, over a cycle, of the instantaneous product of current and voltage, and the apparent power is the product of the rms value of current times the rms value of voltage. If both current and voltage are sinusoidal and in phase, the power factor is 1.0. If both are sinusoidal but not in phase, the power factor is the cosine of the phase angle.

In this disclosure, freewheeling diodes are described. A freewheeling diode, also called a flyback diode, is a diode connected across an inductor used to eliminate flyback, which is the sudden voltage spike seen across an inductive load when its supply current is suddenly reduced or interrupted. It is used in circuits in which inductive loads are controlled by switches, and in switching power supplies and inverters. This diode is known by many other names, such as snubber diode, commutating diode, suppressor diode, clamp diode, or catch diode.

In this disclosure, commutation paths are described. In general, a commutation path (or commutation cell) comprises at least two switching devices, being the most basic one composed by only a switch and a diode. According to the switch state, an on-state and an off-state are defined. By controlling the on and off times (duty cycle) of that switch, a voltage and/or a current can be regulated.

According to a first aspect, the disclosure relates to a power converter, comprising: an alternate current, AC, terminal for providing an input phase voltage; a first direct current, DC, terminal for providing a first DC voltage referred to a third DC terminal; a second DC terminal for providing a second DC voltage referred to the third DC terminal; a first commutation path between the AC terminal and the second DC terminal, the first commutation configured for a first on-state and a first off-state, wherein the first commutation path is active during a positive half-cycle of the input phase voltage and configured to switch between storing energy provided by the AC terminal in a first energy storage during the first on-state and transferring the stored energy to the second DC terminal during the first off-state; a second commutation path between the AC terminal and the first DC terminal, the second commutation path configured for a second on-state and a second off-state, wherein the second commutation path is active during a positive half-cycle of the input phase voltage and configured to switch between storing energy provided by the AC terminal in the first energy storage, at the same time transferring energy to the second DC terminal, during the second on-state and transferring the stored energy to the first DC terminal during the second off-state; a third commutation path between the AC terminal and the second DC terminal, the third commutation path configured for a third on-state and a third off-state, wherein the third commutation path is active during a negative half-cycle of the input phase voltage and configured to switch between storing energy provided by the AC terminal in a second energy storage during the third on-state and transferring the stored energy to the second DC terminal during the third off-state; and a fourth commutation path between the AC terminal and the first DC terminal, the fourth commutation path configured for a fourth on-state and a fourth off-state, wherein the fourth commutation path is active during a negative half-cycle of the input phase voltage and configured to switch between storing energy provided by the AC terminal in a second energy storage, at the same time transferring energy to the second DC terminal, during the fourth on-state and transferring the stored energy to the first DC terminal during the fourth off-state.

The first on-state and the first off-state are states of the first commutation path, i.e., states in which the switch of the first commutation path is active (on-state) or not active (off-state). The same applies to the second, third and fourth on-state and off-state, respectively: The second on-state and the second off-state are states of the second commutation path; the third on-state and the third off-state are states of the third commutation path; and the fourth on-state and the fourth off-state are states of the fourth commutation path.

The power converter may be configured for power conversion between AC to DC. In particular, the power converter may comprise a power factor correction rectifier configured for rectifying AC power to DC power including power factor correction as described in this disclosure. In particular, the power converter may comprise a 5-level hybrid PFC rectifier for rectifying AC power to DC power based on 5 levels of voltage as described in this disclosure.

Such a power converter has reduced volume and weight. The power converter may be used as a single-phase PFC rectifier. The power converter can be implemented with magnetic components of reduced weight without the need for increasing the switching frequency. The power converter is a compact device at low weight and volume.

The additional commutation paths of this novel 5-level PFC Rectifier circuitry enable to reduce the voltages carried by the magnetic components and thus their sizes and weight. The additional commutation paths can be connected to a second DC-link capacitor C₂. Depending on the phase angle of the sine wave, the converter will select the one out of the available DC-links that best matches the required output voltage levels.

In an embodiment, the first DC terminal and the second DC terminal are coupled via respective capacitors to the third DC terminal.

This provides the advantage that a first configuration of the power converter implemented with common ground DC-link capacitors can be implemented. Using this configuration, a common ground can be used to simplify the circuit design.

In an embodiment, the first DC terminal is coupled via a first capacitor to the second DC terminal and the second DC terminal is coupled via a second capacitor to the third DC terminal.

This provides the advantage that a second configuration of the power converter implemented with split DC-link capacitors can be implemented. Using this configuration, two different capacitors at different potential can be implemented as an alternative circuit design.

In an embodiment, the power converter is configured for a first operation mode or a second operation mode according to the input phase voltage and the second DC voltage.

This provides the advantage that the separation into two operation modes enables to reduce the voltage provided across the energy storage elements. Hence the size of the magnetic components of the energy storage elements required for carrying the respective power can be reduced, thereby reducing the overall weight and volume of the power converter.

In an embodiment, in the first operation mode, the input phase voltage is lower than or equal to the second DC voltage and in the second operation mode, the input phase voltage is higher than the second DC voltage.

As the input phase voltage can be positive or negative, the input phase voltage being lower or equal to the second DC voltage means in this context that an absolute value of the input phase voltage is lower or equal to the second DC voltage. The same applies for the contrary case: The input phase voltage being higher or equal to the second DC voltage means in this context that an absolute value of the input phase voltage is higher or equal to the second DC voltage.

Depending on the absolute values of the input phase voltage and the second DC voltage, the power converter is operating in the first or second operation mode. Hence, operation of the power converter in these two operation modes achieves a reduction of the power to be carried by the energy storage elements which results in a size and weight reduction of these elements.

In an embodiment, the power converter comprises: a switching circuit comprising a series connection of a diode D9 and a switch S10 placed between a first internal node and the second DC terminal; a switch S2 placed between the first internal node and the third DC terminal; a diode D6 placed between the third DC terminal and a fourth internal node, the diode D6 forming a return path for both, the first on-state and the first off-state of the first commutation path, wherein in the first operation mode, the first commutation path is activated during the positive half-cycle of the input phase voltage, wherein the switch S10 of the switching circuit is configured to be permanently closed during the first operation mode and the switch S2 is configured to be closed during the first on-state of the first commutation path, storing the energy provided by the AC terminal in the first energy storage, and to be opened during the first off-state of the first commutation path, transferring the stored energy to the second DC terminal through a freewheeling path composed by the series connection of the diode D9 and the switch S10 of the switching circuit.

By this configuration of the power converter, the two stages of energy storage and energy transfer can be included during a switching period in the positive half-cycle of the input phase voltage. This configuration is applied when the absolute value of the input phase voltage is smaller or equal than the second DC voltage. For such a power converter that operates based on a 5-level topology due to the additional commutation paths as described in this disclosure, the voltage across the first energy storage can be kept within a predefined voltage range that is smaller than a voltage range to be specified for a 3-level topology power converter.

In an embodiment, the power converter further comprises: a freewheeling diode D1 placed between the first internal node and the first DC terminal, wherein in the second operation mode, the second commutation path is activated during the positive half-cycle of the input phase voltage, wherein the switch S2 is configured to be permanently opened during the second operation mode and the switch S10 is configured to be closed during the second on-state of the second commutation path, storing the energy provided by the AC terminal in the first energy storage and transferring energy to the second DC terminal, and to be opened during the second off-state of the second commutation path, transferring the stored energy to the first DC terminal through the freewheeling diode D1, and the diode D6 forming the return path for both the second on-state and the second off-state of the second commutation path.

The freewheeling diode D1, also called flyback diode, is a diode connected across an inductor (the first energy storage or L1) used to eliminate flyback, which is the sudden voltage spike seen across an inductive load when its supply current is suddenly reduced or interrupted. The freewheeling diode D1 is used in circuits in which inductive loads are controlled by switches, such as the disclosed power converter, and in switching power supplies and inverters.

This configuration of the power converter provides the advantage of including the two stages of energy storage and energy transfer during a switching period in the positive half-cycle of the input phase voltage. This configuration is applied when the absolute value of the input phase voltage is higher than the second DC voltage. As described above, such a power converter that operates based on a 5-level topology due to the additional commutation paths as described in this disclosure, the voltage across the first energy storage can be kept within a predefined voltage range even when operating at an input phase voltage that is higher than the second DC voltage. This results in smaller magnetic components for the first energy storage and hence reduced size and weight of the whole power converter.

In an embodiment, the power converter comprises: a switch S4 placed between the third DC terminal and a second internal node; the switching circuit comprising a series connection of a diode D11 and a switch S12 between the second internal node and the second DC terminal; a diode D8 placed between the third DC terminal and a third internal node, the diode D8 forming a return path for both the third on-state and the third off-state of the third commutation path, wherein in the first operation mode, the third commutation path is activated during the negative half-cycle of the input phase voltage, wherein the switch S12 of the switching circuit is configured to be permanently closed during the first operation mode and the switch S4 is configured to be closed during the third on-state of the third commutation path, storing the energy provided by the AC terminal in the second energy storage, and to be opened during the third off-state of the third commutation path, transferring the stored energy to the second DC terminal through a freewheeling path composed by the series connection of the diode D11 and the switch S12 of the switching circuit.

This configuration of the power converter provides the advantage of including the two stages of energy storage and energy transfer during a switching period in the negative half-cycle of the input phase voltage. This configuration is applied when the absolute value of the input phase voltage is smaller or equal than the second DC voltage. As described above, for such a power converter that operates based on a 5-level topology due to the additional commutation paths (third and fourth commutation path) as described in this disclosure, the voltage across the second energy storage can be kept within a predefined voltage range. This results in smaller magnetic components for the second energy storage and hence reduced size and weight of the whole power converter.

In an embodiment, the power converter comprises: a freewheeling diode D3 placed between the second internal node and the first DC terminal, wherein in the second operation mode, the fourth commutation path is activated during the negative half-cycle of the input phase voltage, wherein the switch S4 is configured to be permanently opened during the second operation mode and the switch S12 is configured to be closed during the fourth on-state of the fourth commutation path, storing the energy provided by the AC terminal in the second energy storage and transferring energy to the second DC terminal, and to be opened during the fourth off-state of the fourth commutation path, transferring the stored energy to the first DC terminal through the freewheeling diode D3, wherein the diode D8 forms a return path for both the fourth on-state and the fourth off-state of the fourth commutation path.

The freewheeling diode D3, also called flyback diode, is a diode connected across an inductor (the second energy storage or L2) used to eliminate flyback, which is the sudden voltage spike seen across an inductive load when its supply current is suddenly reduced or interrupted. The freewheeling diode D3 is used in circuits in which inductive loads are controlled by switches, such as the disclosed power converter, and in switching power supplies and inverters.

This configuration of the power converter provides the advantage of including the two stages of energy storage and energy transfer during a switching period in the negative half-cycle of the input phase voltage. This configuration is applied when the absolute value of the input phase voltage is higher than the second DC voltage. As described above, for such a power converter that operates based on a 5-level topology due to the additional commutation paths (third and fourth commutation path) as described in this disclosure, the voltage across the second energy storage can be kept within a predefined voltage range. This results in smaller magnetic components for the second energy storage and hence reduced size and weight of the whole power converter.

In an embodiment, the power converter comprises a switching circuit that comprises a series connection of a diode D9 and a switch S10, being configured to switch during a positive half-cycle of the input phase voltage; and wherein the switching circuit comprises a series connection of a diode D11 and a switch S12, being configured to switch during a negative half-cycle of the input phase voltage.

The power converter can be advantageously designed based on different configurations of the switching circuit. The switching circuit can be advantageously applied to connect the additional commutation paths to the second DC terminal, thereby providing a 5-level power converter topology with the above described advantages.

Such a first configuration provides the advantage of independent switching paths for all commutation paths.

In an embodiment, the power converter comprises a switching circuit that comprises a series connection of a diode D9 and a switch S10, being configured to switch during a positive half-cycle of the input phase voltage; and wherein the switching circuit comprises a series connection of a diode D11 and the switch S10, being configured to switch during a negative half-cycle of the input phase voltage.

Such a second configuration of the switching circuit provides the advantage of reduced electronic components, since a single switch S10 and two additional diodes are sufficient to implement the functionality of the switching circuit.

In an embodiment, the power converter comprises a switching circuit that comprises a series connection of a switch S9 and a diode D10, being configured to switch during a positive half-cycle of the input phase voltage; and wherein the switching circuit comprises a series connection of a switch S11 and a diode D12, being configured to switch during a negative half-cycle of the input phase voltage.

Such a third configuration of the switching circuit provides an alternative to the first configuration. It provides the advantage of independent switching paths for all commutation paths.

In an embodiment, the power converter comprises a switching circuit that comprises a series connection of a switch S9 and a switch S10, being configured to switch during a positive half-cycle of the input phase voltage; and wherein the switching circuit comprises a series connection of a switch S11 and a switch S12, being configured to switch during a negative half-cycle of the input phase voltage.

Such a fourth configuration of the switching circuit is described with respect to FIG. 3d.

Such a fourth configuration of the switching circuit provides an alternative to the first configuration. It provides the advantage of enabling the reduction of the conduction losses produced by the diodes by using synchronous rectification.

Any of the switches S2, S4, S9, S10, S11 and S12 may comprise a transistor, a high-electron mobility Gallium-Nitride transistor, GaN-HEMT, or a metal—oxide—semiconductor field-effect transistor, MOSFET, or an insulated gate bipolar transistor, IGBT.

In an embodiment, the first energy storage comprises a first inductor; and the second energy storage comprises a second inductor.

This provides the advantage that the energy storages can be easily implemented by using inductors which are available for different nominal currents and powers.

In an embodiment, the first inductor and the second inductor are coupled inductors coupled via a magnetic coupling device.

This provides the advantage that the coupling of the inductors can increase their utilization factor and reduce their size.

According to a second aspect, the disclosure relates to a method for configuring a power converter, wherein the power converter comprises: an alternate current, AC, terminal for providing an input phase voltage; a first direct current, DC, terminal for providing a first DC voltage referred to a third DC terminal; a second DC terminal for providing a second DC voltage referred to the third DC terminal; a first commutation path between the AC terminal and the second DC terminal, a second commutation path between the AC terminal and the first DC terminal, a third commutation path between the AC terminal and the second DC terminal, and a fourth commutation path between the AC terminal and the first DC terminal, wherein the method comprises: configuring the first commutation path for a first on-state and a first off-state, wherein the first commutation path is active during a positive half-cycle of the input phase voltage; configuring the first commutation path to switch between storing energy provided by the AC terminal in a first energy storage during the first on-state and transferring the stored energy to the second DC terminal during the first off-state; configuring the second commutation path for a second on-state and a second off-state, wherein the second commutation path is active during a positive half-cycle of the input phase voltage; configuring the second commutation path to switch between storing energy provided by the AC terminal in the first energy storage, at the same time transferring energy to the second DC terminal, during the second on-state and transferring the stored energy to the first DC terminal during the second off-state; configuring the third commutation path for a third on-state and a third off-state, wherein the third commutation path is active during a negative half-cycle of the input phase voltage; configuring the third commutation path to switch between storing energy provided by the AC terminal in a second energy storage during the third on-state and transferring the stored energy to the second DC terminal during the third off-state; configuring the fourth commutation path for a fourth on-state and a fourth off-state, wherein the fourth commutation path is active during a negative half-cycle of the input phase voltage; and

configuring the fourth commutation path to switch between storing energy provided by the AC terminal in a second energy storage, at the same time transferring energy to the second DC terminal, during the fourth on-state and transferring the stored energy to the first DC terminal during the fourth off-state.

Such a method can be applied for configuring a power converter of reduced volume and weight. The method can configure a power converter being used as a single-phase PFC rectifier. The power converter can be implemented with magnetic components of reduced weight without the need for increasing the switching frequency.

The method can configure a power converter with additional commutation paths that allow to reduce the voltages carried by the magnetic components of the power converter. The method can advantageously connect the additional commutation paths of the power converter to a second DC-link capacitor C₂. Depending on the phase angle of the sine wave, the method can configure the power converter to select the one out of the available DC-links that best matches the required output voltage levels.

According to a third aspect, the disclosure relates to a method for operating a power converter, wherein the power converter comprises: an alternate current, AC, terminal for providing an input phase voltage; a first direct current, DC, terminal for providing a first DC voltage referred to a third DC terminal; a second DC terminal for providing a second DC voltage referred to the third DC terminal; a first commutation path between the AC terminal and the second DC terminal, the first commutation path configured for a first on-state and a first off-state, a second commutation path between the AC terminal and the first DC terminal, the second commutation path configured for a second on-state and a second off-state, a third commutation path between the AC terminal and the second DC terminal, the third commutation path configured for a third on-state and a third off-state, and a fourth commutation path between the AC terminal and the first DC terminal, the fourth commutation path configured for a fourth on-state and a fourth off-state, wherein the method comprises: activating the first commutation path during a positive half-cycle of the input phase voltage; switching, by the first commutation path, between storing energy provided by the AC terminal in a first energy storage during the first on-state and transferring the stored energy to the second DC terminal during the first off-state; activating the second commutation path during a positive half-cycle of the input phase voltage; switching, by the second commutation path, between storing energy provided by the AC terminal in the first energy storage, at the same time transferring energy to the second DC terminal, during the second on-state and transferring the stored energy to the first DC terminal during the second off-state; activating the third commutation path during a negative half-cycle of the input phase voltage; switching, by the third commutation path, between storing energy provided by the AC terminal in a second energy storage during the third on-state and transferring the stored energy to the second DC terminal during the third off-state; activating the fourth commutation path during a negative half-cycle of the input phase voltage; and switching, by the fourth commutation path, between storing energy provided by the AC terminal in a second energy storage, at the same time transferring energy to the second DC terminal, during the fourth on-state and transferring the stored energy to the first DC terminal during the fourth off-state.

Such a method can be applied for configuring a power converter of reduced volume and weight. The method can configure a power converter being used as a single-phase PFC rectifier. The power converter can be implemented with magnetic components of reduced weight without the need for increasing the switching frequency.

The method can advantageously operate a power converter with additional commutation paths that allow to reduce the voltages carried by the magnetic components of the power converter. The method can advantageously connect the additional commutation paths of the power converter to a second DC-link capacitor C₂. Depending on the phase angle of the sine wave, the method can operate the power converter to select the one out of the available DC-links that best matches the required output voltage levels.

According to a fourth aspect, the disclosure relates to a computer program product including computer executable code or computer executable instructions that, when executed, causes at least one computer to execute the method according to the second or third aspect described above.

The computer program product may run on a controller or a processor for controlling the above described power converter.

According to a fifth aspect, the disclosure relates to a computer-readable medium, storing instructions that, when executed by a computer, cause the computer to execute the method according to the second or third aspect described above. Such a computer readable medium may be a non-transient readable storage medium. The instructions stored on the computer-readable medium may be executed by a controller or a processor.

### BRIEF DESCRIPTION OF THE DRAWINGS

Further embodiments of the invention will be described with respect to the following figures, in which:

FIG. 1a shows a circuit diagram of an exemplary power converter 200 according to an embodiment of the disclosure in a first DC link configuration;

FIG. 1b shows a circuit diagram of an exemplary power converter 100 according to an embodiment of the disclosure in a second DC link configuration;

FIG. 1c shows a circuit diagram of the power converter 200 in a first operation mode for a positive half-cycle of the input phase voltage;

FIG. 1d shows a circuit diagram of the power converter 200 in a second operation mode for the positive half-cycle of the input phase voltage;

FIG. 1e shows a circuit diagram of the power converter 200 in the first operation mode for a negative half-cycle of the input phase voltage;

FIG. 1f shows a circuit diagram of the power converter 200 in the second operation mode for the negative half-cycle of the input phase voltage;

FIG. 1g shows different exemplary time diagrams 201, 202, 203, 204, 205, 206, 207 illustrating the main waveforms of a power converter 200 according to an embodiment of the disclosure;

FIG. 1h shows a block diagram implementing an exemplary phase disposition pulse width modulation 300 for controlling a power converter 200 according to an embodiment of the disclosure;

FIG. 1i shows a performance diagram illustrating an exemplary duty-cycle behavior for the switches S2 and S10 of a power converter 200 according to an embodiment of the disclosure;

FIG. 2a shows a circuit diagram of the power converter 200 with coupled inductors according to an embodiment of the disclosure;

FIG. 2b shows a circuit diagram of the power converter 100 with coupled inductors according to an embodiment of the disclosure;

FIG. 3a shows a circuit diagram illustrating a first example of a switching circuit 105a of a power converter 100, 200 according to an embodiment of the disclosure;

FIG. 3b shows a circuit diagram illustrating a second example of a switching circuit 105b of a power converter 100, 200 according to an embodiment of the disclosure;

FIG. 3c shows a circuit diagram illustrating a third example of a switching circuit 105c of a power converter 100, 200 according to an embodiment of the disclosure;

FIG. 3d shows a circuit diagram illustrating a fourth example of a switching circuit 105d of a power converter 100, 200 according to an embodiment of the disclosure;

FIG. 4a shows two voltage diagrams 401, 402 illustrating the principle of voltage conversion for a 3-level power converter and a 5-level power converter 100, 200 according to an embodiment of the disclosure;

FIG. 4b shows a performance diagram illustrating behavior of the normalized ripple current 501, 502 for a power converter according to a 3-level conversion topology and for the power converter 100, 200 based on a 5-level conversion topology according to an embodiment of the disclosure;

FIG. 5 shows a diagram illustrating inductances 501, 502, 503 for topologies with different voltage levels according to an embodiment;

FIG. 6 shows a schematic diagram illustrating a method 600 for configuring a power converter according to an embodiment of the disclosure; and

FIG. 7 shows a schematic diagram illustrating a method 700 for operating a power converter according to an embodiment of the disclosure.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

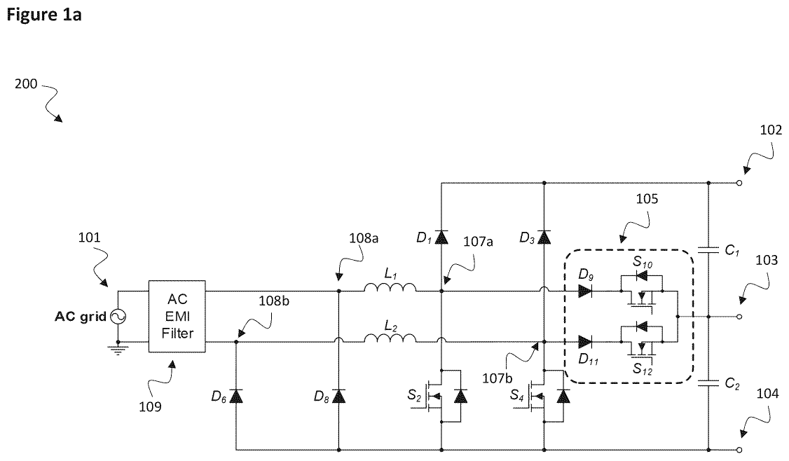

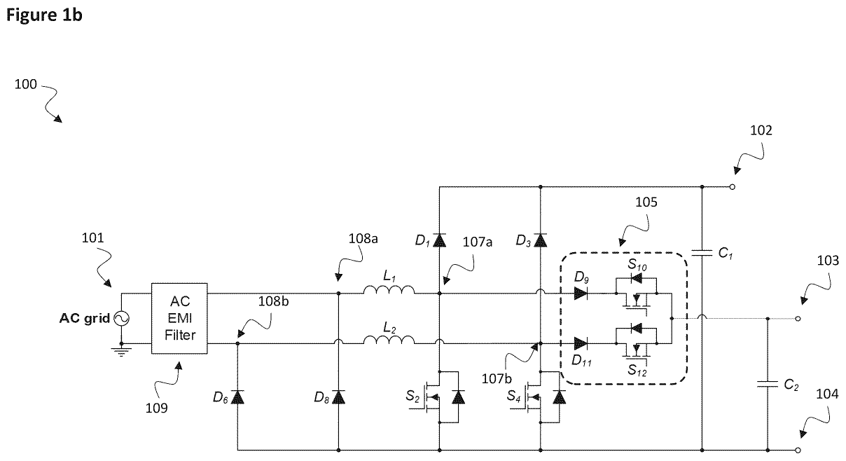

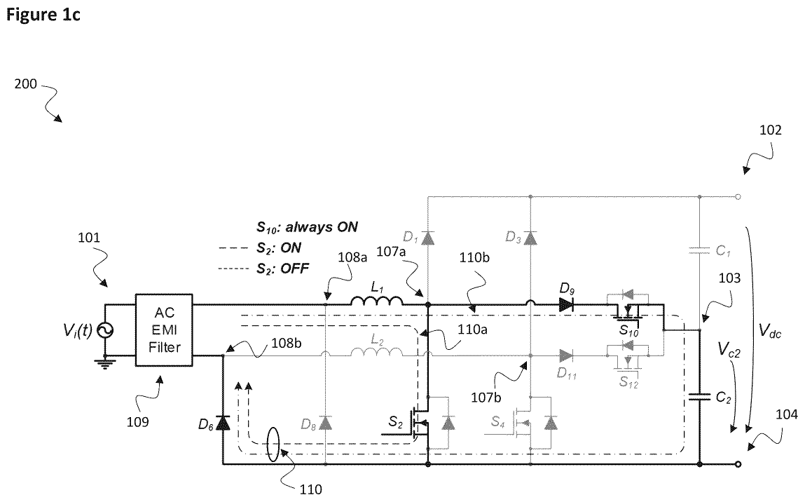

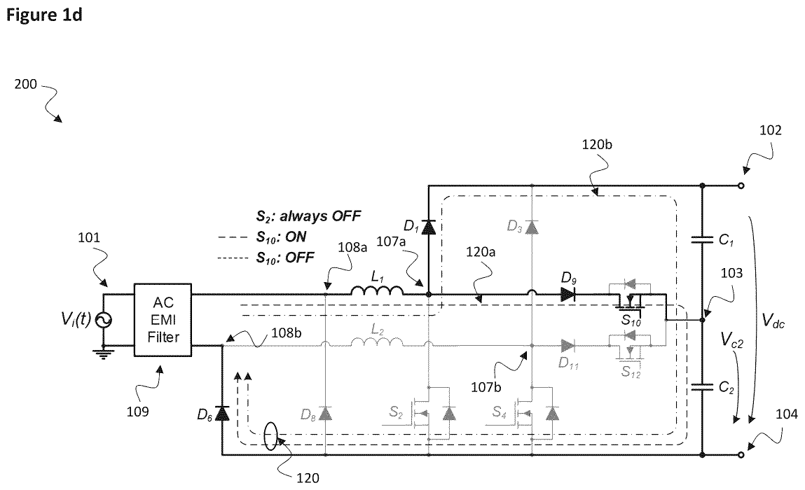

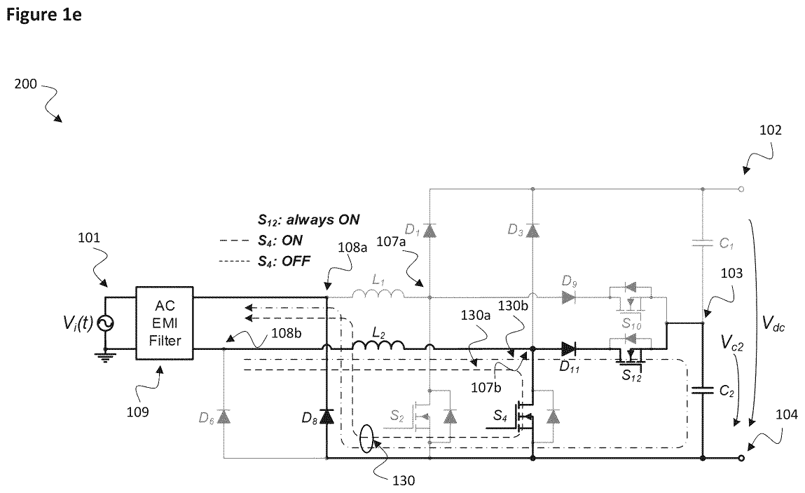

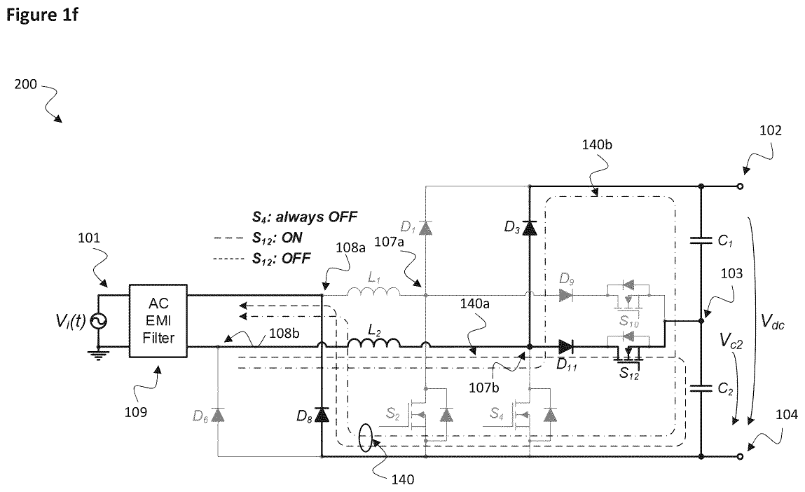

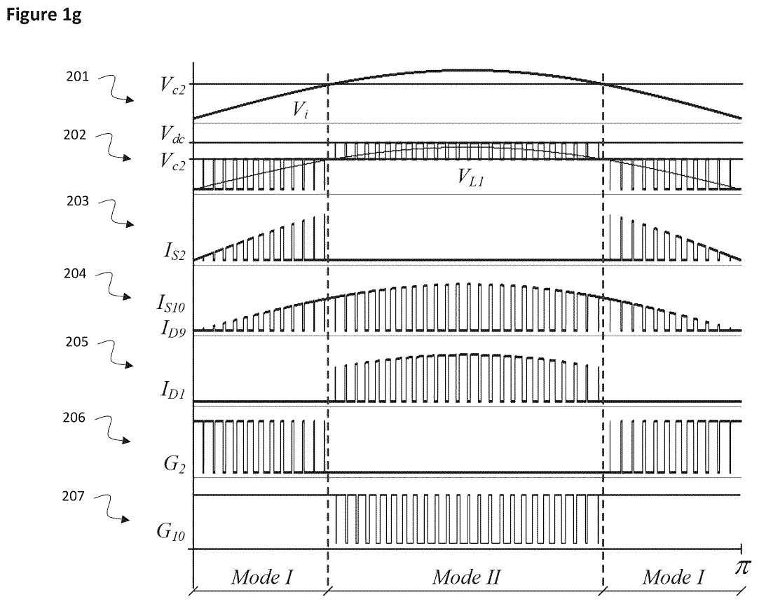

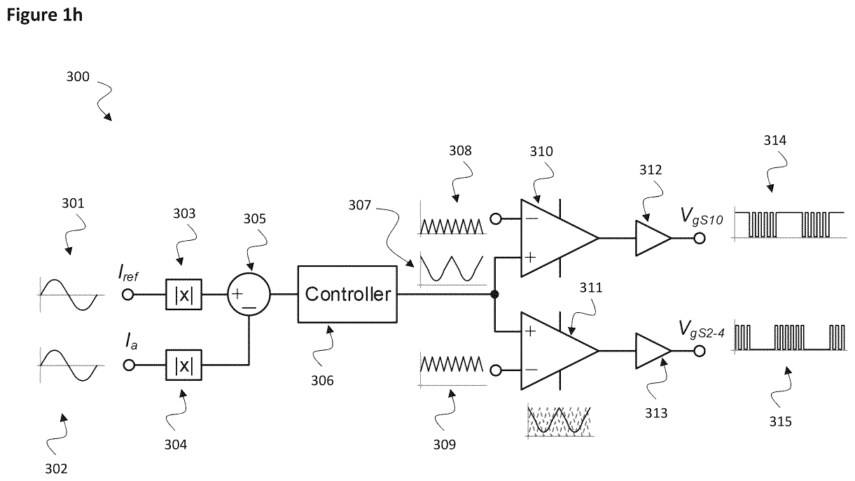

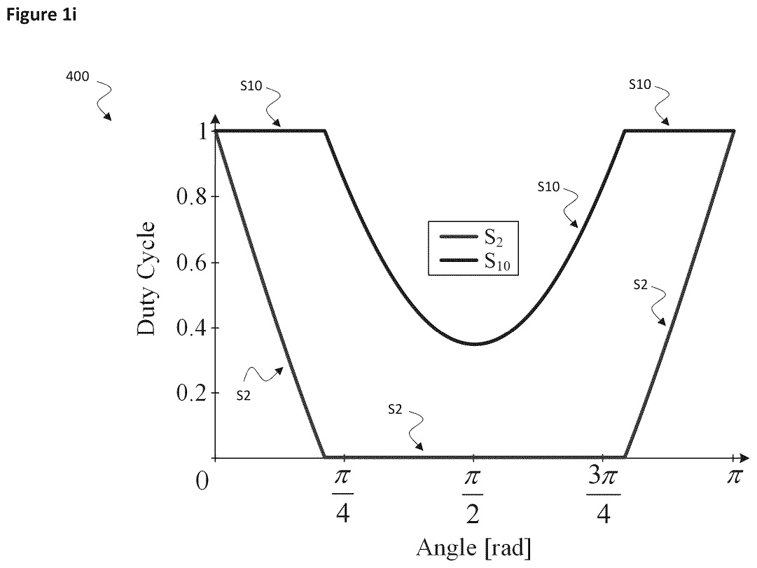

FIG. 1a shows a circuit diagram of an exemplary power converter 200 according to an embodiment of the disclosure in a first DC link configuration.

The power converter 200 comprises an alternate current, AC, terminal 101 for providing an input phase voltage Vᵢ(t), corresponding to the AC grid voltage in FIG. 1a. The power converter 200 comprises a first direct current, DC, terminal 102 for providing a first DC voltage V_{DC} referred to a third DC terminal 104; and a second DC terminal 103 for providing a second DC voltage V_{c2} referred to the third DC terminal 104. A first DC capacitor C₁ is connected between the first DC terminal 102 and the second DC terminal 103. A second DC capacitor C2 is connected between the second DC terminal 103 and the third DC terminal 104. The first DC terminal 102 and the second DC terminal 103 are coupled via the respective capacitors C₁, C₂ to the third DC terminal 104. In this configuration, capacitor C₂ is configured as split DC-link together with C₁ as depicted in FIG. 1a.

The power converter 200 comprises a switching circuit 105 between a first internal node 107a, a second internal node 107b and the second DC terminal 103. The switching circuit 105 comprises a first path between the first internal node 107a and the second DC terminal 103 and a second path between the second internal node 107b and the second DC terminal 103. The first path comprises a series connection of a diode D9 and a switch S10. The second path comprises a series connection of a diode D11 and a switch S12.

A first energy storage formed as a first inductor L₁ is arranged between the third internal node 108a and the first internal node 107a. A second energy storage formed as a second inductor L₂ is arranged between the fourth internal node 108b and the second internal node 107b.

A diode D1 is arranged between the first internal node 107a and the first DC terminal 102. A diode D3 is arranged between the second internal node 107b and the first DC terminal 102.

A switch S2 is arranged between the third DC terminal 104 and the first internal node 107a. A switch S4 is arranged between the third DC terminal 104 and the second internal node 107b.

A diode D6 is arranged between the third DC terminal 104 and the fourth internal node 108b. A diode D8 is arranged between the third DC terminal 104 and the third internal node 108a.

An AC EMI (electromagnetic interference) filter 109 is arranged between the AC terminal 101 and the third internal node 108a and the fourth internal node 108b. The AC EMI filter 109 is used for filtering interfering influences of the AC grid voltage.

Electromagnetic interference (EMI), also called radio-frequency interference (RFI) when in the radio frequency spectrum, is a disturbance generated by an external source that affects an electrical circuit by electromagnetic induction, electrostatic coupling, or conduction. The disturbance may degrade the performance of the circuit or even stop it from functioning. In the case of a data path, these effects can range from an increase in error rate to a total loss of the data. Both man-made and natural sources generate changing electrical currents and voltages that can cause EMI. The AC EMI filter 109 is used for cancelling these EMI distortions.

The power converter 200 comprises a first commutation path between the AC terminal 101 and the second DC terminal 103, a second commutation path 120 between the AC terminal 101 and the first DC terminal 102, a third commutation path 130 between the AC terminal 101 and the second DC terminal 103 and a fourth commutation path 140 between the AC terminal 101 and the first DC terminal 102. The functionality of these commutation paths is described below with respect to FIGS. 1c to 1f.

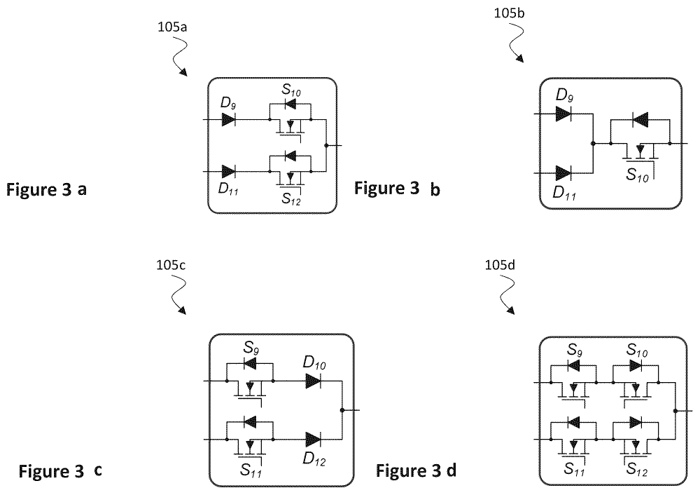

The switching circuit 105 can be designed as shown in FIG. 1a. However, alternative designs of this switching circuit can be implemented as well, e.g., according to the circuit designs described below with respect to FIGS. 3a to 3d.

The power converter 200 of FIG. 1a can be designed by adding two commutation paths to the circuit design of a 3-level power converter, e.g., of a 3-level PFC Rectifier. This addition of commutation paths results in a novel 5-level power converter, e.g., 5-level PFC Rectifier as depicted in FIG. 1a. These commutation paths are connected to the second DC-link capacitor C₂. Depending on the phase angle of the sine wave, the converter will select the one out of the available DC-links that best matches the required output voltage levels.

FIG. 1b shows a circuit diagram of an exemplary power converter 100 according to an embodiment of the disclosure in a second DC link configuration.

The circuitry configuration of the power converter 100 corresponds to the circuitry configuration of the power converter 200 described above with respect to FIG. 1a. The only difference is the DC terminal circuitry configuration: The first DC capacitor C₁ is connected between the first DC terminal 102 and the third DC terminal 104 and the second DC capacitor C₂ is connected between the second DC terminal 103 and the third DC terminal 104. The first DC terminal 102 is coupled via the first capacitor C₁ to the second DC terminal 103 and the second DC terminal 103 is coupled via the second capacitor C₂ to the third DC terminal 104. In this configuration, a common ground is used for both DC-link capacitor C₁ and C₂ as depicted in FIG. 1b.

FIG. 1c shows a circuit diagram of the power converter 200 in a first operation mode for a positive half-cycle of the input phase voltage.

The circuitry configuration of the power converter 200 depicted in FIG. 1c corresponds to the circuitry configuration of the power converter 200 described above with respect to FIG. 1a.

The power converter 200 comprises a first commutation path 110 between the AC terminal 101 and the second DC terminal 103, a second commutation path 120 between the AC terminal 101 and the first DC terminal 102, a third commutation path 130 between the AC terminal 101 and the second DC terminal 103 and a fourth commutation path 140 between the AC terminal 101 and the first DC terminal 102. In the circuit diagram shown in FIG. 1c, the first commutation path 110 is highlighted. The functionality of this first commutation path 110 is described in the following.

The first commutation path 110 is configured for a first on-state 110a and a first off-state 110b. The first commutation path 110 is active during a positive half-cycle of the input phase voltage Vᵢ(t) and configured to switch between storing energy provided by the AC terminal 101 in the first energy storage L1 during the first on-state 110a and transferring the stored energy to the second DC terminal 103 during the first off-state 110b.

The power converter 200 is configured for a first operation mode or a second operation mode according to the input phase voltage Vᵢ(t) and the second DC voltage V_{C2}. In the first operation mode, the input phase voltage Vᵢ(t) is lower than or equal to the second DC voltage V_{C2} and in the second operation mode, the input phase voltage Vᵢ(t) is higher than the second DC voltage V_{C2}.

In the first operation mode, the first commutation path 110 is activated during the positive half-cycle of the input phase voltage Vᵢ(t), wherein the switch S10 of the switching circuit 105 is configured to be permanently closed during the first operation mode and the switch S2 is configured to be closed during the first on-state 110a of the first commutation path 110, storing the energy provided by the AC terminal 101 in the first energy storage L1, and to be opened during the first off-state 110b of the first commutation path 110, transferring the stored energy to the second DC terminal 103 through a freewheeling path composed by the series connection of the diode D9 and the switch S10 of the switching circuit 105.

The principle of operation can easily be explained in two steps, depending on the relation between the instantaneous input and output voltages. Each leg is responsible for one half-cycle of the grid. The operation is similar during the positive and negative half-cycle.

In the first operation mode, the absolute value of the instantaneous input phase voltage Vᵢ(t) is lower than or equal to the voltage across C₂, V_{c2}, i.e., |Vᵢ(t)|≤V_{c2}. In this mode, all the energy provided by the phase input is delivered to C₂ via the bypass path. The operation is similar to a DC/DC boost converter, presenting the two stages of energy storage and transfer during a switching period. In the positive half-cycle of the AC input voltage Vᵢ(t), the energy is stored in the inductor Li through the high frequency switch S2 and transferred to the DC-link C2 through the freewheeling path composed by D₉ and S₁₀, as depicted in FIG. 1c. The bypass switch S₁₀ is always closed in this mode and D₆ is the return path for both stages.

Figure Id shows a circuit diagram of the power converter 200 in a second operation mode for the positive half-cycle of the input phase voltage.

The circuitry configuration of the power converter 200 depicted in FIG. 1d corresponds to the circuitry configuration of the power converter 200 described above with respect to FIG. 1a.

The power converter 200 comprises a first commutation path 110 between the AC terminal 101 and the second DC terminal 103, a second commutation path 120 between the AC terminal 101 and the first DC terminal 102, a third commutation path 130 between the AC terminal 101 and the second DC terminal 103 and a fourth commutation path 140 between the AC terminal 101 and the first DC terminal 102. In the circuit diagram shown in FIG. 1d, the second commutation path 120 is highlighted. The functionality of this second commutation path 120 is described in the following.

The second commutation path 120 is configured for a second on-state 120a and a second off-state 120b. The second commutation path 120 is active during a positive half-cycle of the input phase voltage Vᵢ(t) and configured to switch between storing energy provided by the AC terminal 101 in the first energy storage L1, at the same time transferring energy to the second DC terminal 103, during the second on-state 120a and transferring the stored energy to the first DC terminal 102 during the second off-state 120b.

In the second operation mode, the second commutation path 120 is activated during the positive half-cycle of the input phase voltage Vᵢ(t). The switch S2 is configured to be permanently opened during the second operation mode and the switch S10 is configured to be closed during the second on-state 120a of the second commutation path 120, storing the energy provided by the AC terminal 101 in the first energy storage L1 and transferring energy to the second DC terminal 103. The switch S2 is configured to be opened during the second off-state 120b of the second commutation path 120, transferring the stored energy to the first DC terminal 102 through the freewheeling diode D1, and the diode D6 forming the return path for both the on-state 120a and the off-state 120b of the second commutation path 120.

The principle of operation can easily be explained in two steps, depending on the relation between the instantaneous input and output voltages. Each leg is responsible for one half-cycle of the grid. The operation is similar during the positive and negative half-cycle.

Unlike the first operation mode, the second one occurs when the absolute value of the instantaneous input phase voltage Vᵢ(t) is higher than V_{c2}, i.e., |Vᵢ(t)|>V_{c2}. In this mode, the energy provided by input is delivered to both DC-links. In the positive half-cycle of the AC input voltage Vᵢ(t), the energy storage in the inductor occurs through D₉ and S₁₀ (switching at high frequency), at the same time delivering energy to C₂. The stage of energy transfer to C₁ is performed through the freewheeling diode D₁, as shown in FIG. 1d. Switch S₂ remains blocked in this mode and D₆ is the return path for both stages.

FIG. 1e shows a circuit diagram of the power converter 200 in the first operation mode for a negative half-cycle of the input phase voltage.

The circuitry configuration of the power converter 200 depicted in FIG. 1e corresponds to the circuitry configuration of the power converter 200 described above with respect to FIG. 1a.

The power converter 200 comprises a first commutation path 110 between the AC terminal 101 and the second DC terminal 103, a second commutation path 120 between the AC terminal 101 and the first DC terminal 102, a third commutation path 130 between the AC terminal 101 and the second DC terminal 103 and a fourth commutation path 140 between the AC terminal 101 and the first DC terminal 102. In the circuit diagram shown in FIG. 1e, the third commutation path 130 is highlighted. The functionality of this third commutation path 130 is described in the following.

The third commutation path 130 is configured for a third on-state 130a and a third off-state 130b. The third commutation path 130 is active during a negative half-cycle of the input phase voltage Vᵢ(t) and configured to switch between storing energy provided by the AC terminal 101 in the second energy storage L2 during the third on-state 130a and transferring the stored energy to the second DC terminal 103 during the third off-state 130b.

In the first operation mode, i.e. |Vᵢ(t)|≤V_{c2}, the third commutation path 130 is activated during the negative half-cycle of the input phase voltage Vᵢ(t). The switch S12 of the switching circuit 105 is configured to be permanently closed during the first operation mode and the switch S4 is configured to be closed during the third on-state 130a of the third commutation path 130, storing the energy provided by the AC terminal 101 in the second energy storage L2. The switch S4 is configured to be opened during the third off-state 130b of the third commutation path 130, transferring the stored energy to the second DC terminal 103 through a freewheeling path composed by the series connection of the diode D11 and the switch S12 of the switching circuit 105.

As described above, the principle of operation can easily be explained in two steps, depending on the relation between the instantaneous input and output voltages. Each leg is responsible for one half-cycle of the grid. The operation is similar during the positive and negative half-cycle.

In the negative half-cycle, the energy is stored in the inductor L₂ through the high frequency switch S₄ and transferred to the DC-link C₂ through the freewheeling path composed by D₁₁ and S₁₂, as depicted in FIG. 1e. The bypass switch S₁₂ is always closed in this mode and D₈ is the return path for both stages.

FIG. 1f shows a circuit diagram of the power converter 200 in the second operation mode for the negative half-cycle of the input phase voltage.

The circuitry configuration of the power converter 200 depicted in Figure if corresponds to the circuitry configuration of the power converter 200 described above with respect to FIG. 1a.

The power converter 200 comprises a first commutation path 110 between the AC terminal 101 and the second DC terminal 103, a second commutation path 120 between the AC terminal 101 and the first DC terminal 102, a third commutation path 130 between the AC terminal 101 and the second DC terminal 103 and a fourth commutation path 140 between the AC terminal 101 and the first DC terminal 102. In the circuit diagram shown in FIG. 1f, the fourth commutation path 140 is highlighted. The functionality of this fourth commutation path 140 is described in the following.

The fourth commutation path 140 is configured for a fourth on-state 140a and a fourth off-state 140b. The fourth commutation path 140 is active during a negative half-cycle of the input phase voltage Vᵢ(t) and configured to switch between storing energy provided by the AC terminal 101 in a second energy storage L2, at the same time transferring energy to the second DC terminal 103, during the fourth on-state 140a and transferring the stored energy to the first DC terminal 102 during the fourth off-state 140b.

In the second operation mode, i.e., |Vᵢ(t)|>V_{c2}, the fourth commutation path 140 is activated during the negative half-cycle of the input phase voltage Vᵢ(t). The switch S4 is configured to be permanently opened during the second operation mode and the switch S12 is configured to be closed during the fourth on-state 140a of the fourth commutation path 140, storing the energy provided by the AC terminal 101 in the second energy storage L2 and transferring energy to the second DC terminal 103. The switch S12 is configured to be opened during the fourth off-state 140b of the fourth commutation path 140, transferring the stored energy to the first DC terminal 102 through the freewheeling diode D3. The diode D8 forms a return path for both the fourth on-state 140a and the fourth off-state 140b of the fourth commutation path 140.

As described above, the principle of operation can easily be explained in two steps, depending on the relation between the instantaneous input and output voltages. Each leg is responsible for one half-cycle of the grid. The operation is similar during the positive and negative half-cycle.

In the negative half-cycle, the energy storage in the inductor occurs through D₁₁ and S₁₂ (switching at high frequency), at the same time delivering energy to C₂. The stage of energy transfer to C₁ is performed through the freewheeling diode D₃, as shown in FIG. 1f. Switch S₄ remains blocked in this mode and D₈ is the return path for both stages.

FIG. 1g shows different exemplary time diagrams 201, 202, 203, 204, 205, 206, 207 illustrating the main voltage and current waveforms of the power converter 200 described above.

In the first time diagram 201, the input phase voltage Vᵢ(t) is depicted with respect to the DC link voltage V_{c2} across capacitor C2. For |Vᵢ(t)|<V_{c2}, the power converter 200 is in the second operation mode (Mode II) while for |Vᵢ(t)|<=V_{c2}, the power converter 200 is in the first operation mode (Mode I).

In the second time diagram 202, the voltage V_{L1} across the first energy storage L1 is shown. In the first operation mode, V_{L1} is switched between zero and V_{c2}, in the second operation mode, V_{L1} is switched between V_{c2} and V_{dc}.

In the third time diagram 203, the current Iₛ₂ through switch S2 is shown. In the fourth time diagram 204, current Iₛ₁₀ through switch S10 and current I_{D9} through diode D9 is shown. In the fifth time diagram 205, the current IDA through diode D1 is shown.

In the sixth time diagram 206, the voltage across the gate G2 of switch S2, i.e., the control voltage of switch S2 is shown. Switch S2 is commutated in the first operation mode and is kept inactive in the second operation mode.

In the seventh time diagram 207, the voltage across the gate G10 of switch S10, i.e., the control voltage of switch S10 is shown. Switch S10 is kept activated in the first operation mode and is commutated in the second operation mode.

FIG. 1h shows a block diagram implementing an exemplary phase disposition pulse width modulation 300 for controlling a power converter 200 according to an embodiment of the disclosure.

A first sine wave 301 is provided as reference value to a first absolute value generator 303 and a measured AC current 302 is provided to a second absolute value generator 304. The outputs of both absolute value generators 303, 304 are subtracted in a math block 305 and provided to a controller 306. In particular, the math block 305 can subtract the output of the second absolute value generator 304 from the output of the first absolute value generator 303. The output of the controller 306 is provided to a first comparator 310 and a second comparator 311. The first comparator 310 compares the output of the controller 306 with a first triangular waveform 308. The second comparator 311 compares the output of the controller 306 with a second triangular waveform 309 with an offset in relation to the first triangular waveform 308. The output of the first comparator 310 is amplified by a first amplifier 312 (also known as gate driver) to provide a first switching signal 314. The output of the second comparator 311 is amplified by a second amplifier 313 to provide a second switching signal 315.

In order to achieve a natural commutation between the operation modes, the rectifier, i.e., the power converter 200, can be implemented adopting the phase disposition (PD) pulse width modulation (PWM) strategy. The phase disposition (PD) modulation in an N-level system consisting of N-1 vertically disposed carriers in phase. As the 5-level system under study uses absolute values for the calculation of the control variables, it is opted for using just two instead of four carriers. In this way, the switches responsible for the positive and negative cycles will be switched by the same gate signal. The lower carrier is responsible for the modulation of switch S₁₀, while the upper, for S₂ and S₄ as shown in FIG. 1h. It is noteworthy that the input current reference remains purely sinusoidal.

In turn, the duty-cycles of switches S₂ and S₁₀ in the positive half-cycle can be described as follows.

$$\\ {D}_{{S}_{2 , 4}} ( t ) = \vert \begin{matrix}1 - \frac{{V}_{i} \sqrt{2}}{{V}_{{c}_{2}}} sin ( {ω}_{s} t ) & if ( 0 \leq {ω}_{s} t < {θ}_{pos} ) ⋁ ( π - {θ}_{pos} \leq {ω}_{s} t < π ) \\ 0 & otherwise\end{matrix}$$

$$\\ {D}_{{S}_{10}} ( t ) = \vert \begin{matrix}1 & if ( 0 \leq {ω}_{s} t < {θ}_{pos} ) ⋁ ( π - {θ}_{pos} \leq {ω}_{s} t < π ) \\ 1 - \frac{{V}_{i} \sqrt{2} sin ( {ω}_{s} t ) - {V}_{{c}_{2}}}{{V}_{dc} - {V}_{{c}_{2}}} & otherwise\end{matrix}$$

where θₚₒₛ is the phase angle boundary between modes I and II, defined as:

$$\\ {θ}_{pos} = \vert \begin{matrix}arc sin ( \frac{{V}_{{c}_{2}}}{{V}_{i} \sqrt{2}} ) & if {V}_{{c}_{2}} \leq {V}_{i} \sqrt{2} \\ \frac{π}{2} & otherwise\end{matrix}$$

FIG. 1i shows a performance diagram illustrating an exemplary duty-cycle behavior for the switches S2 and S10 of the power converter 200 according to an embodiment of the disclosure.

The following operation condition applies: Vᵢ=230 Vrms, V_{dc}=400 V and V_{c2}=200 V.

For switch S2, the duty cycle ranges between 0 and 1. For switch S10, the duty cycle ranges between about 0.4 and 1.

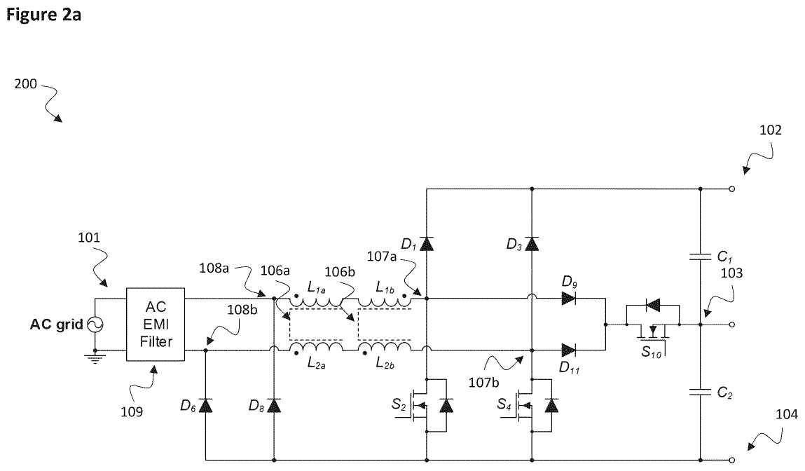

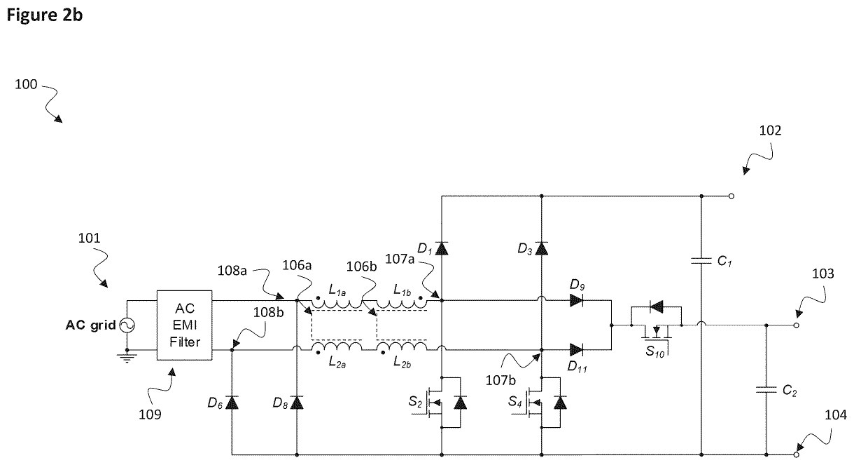

FIG. 2a shows a circuit diagram of the power converter 200 with coupled inductors according to an embodiment of the disclosure.

The circuitry configuration of the power converter 200 corresponds to the circuitry configuration of the power converter 200 described above with respect to FIG. 1a. The only difference is the implementation of the first and second energy storages L1 and L2 which are implemented by coupled inductors L1a, L1b, L2a, L2b which are coupled via a magnetic coupling device 106a, 106b, e.g., a ferrite core.

The power converter 200 may implement a bridgeless dual-boost PFC rectifier with coupled inductors, as depicted in FIG. 2a.

FIG. 2b shows a circuit diagram of the power converter 100 with coupled inductors according to an embodiment of the disclosure.

The circuitry configuration of the power converter 100 corresponds to the circuitry configuration of the power converter 100 described above with respect to FIG. 1b. The only difference is the implementation of the first and second energy storages L1 and L2 which are implemented by coupled inductors L1a, L1b, L2a, L2b which are coupled via a magnetic coupling device 106a, 106b, e.g., a ferrite core.

The power converter 100 may implement a bridgeless dual-boost PFC rectifier with coupled inductors, as depicted in FIG. 2b.

FIG. 3a shows a circuit diagram illustrating a first example of a switching circuit 105a of a power converter 100, 200 according to an embodiment of the disclosure. The switching circuit 105a is one exemplary implementation of the switching circuit 105 described above with respect to FIGS. 1a to 2b.

The switching circuit 105a comprises a series connection of a diode D9 and a switch S10, being configured to switch during a positive half-cycle of the input phase voltage Vᵢ(t). The in the switching circuit 105a further comprises a series connection of a diode D11 and a switch S12, being configured to switch during a negative half-cycle of the input phase voltage Vᵢ(t).

FIG. 3b shows a circuit diagram illustrating a second example of a switching circuit 105b of a power converter 100, 200 according to an embodiment of the disclosure. The switching circuit 105b is one exemplary implementation of the switching circuit 105 described above with respect to FIGS. 1a to 2b.

The switching circuit 105bcomprises a series connection of a diode D9 and a switch S10, being configured to switch during a positive half-cycle of the input phase voltage Vᵢ(t). The switching circuit 105b further comprises a series connection of a diode D11 and a switch S10, being configured to switch during a negative half-cycle of the input phase voltage Vᵢ(t).

FIG. 3c shows a circuit diagram illustrating a third example of a switching circuit 105c of a power converter 100, 200 according to an embodiment of the disclosure. The switching circuit 105c is one exemplary implementation of the switching circuit 105 described above with respect to FIGS. 1a to 2b.

The switching circuit 105c comprises a series connection of a switch S9 and a diode D10, being configured to switch during a positive half-cycle of the input phase voltage Vᵢ(t). The switching circuit 105c further comprises a series connection of a switch S11 and a diode D12, being configured to switch during a negative half-cycle of the input phase voltage Vᵢ(t).

FIG. 3d shows a circuit diagram illustrating a fourth example of a switching circuit 105d of a power converter 100, 200 according to an embodiment of the disclosure. The switching circuit 105d is one exemplary implementation of the switching circuit 105 described above with respect to FIGS. 1a to 2b.

The switching circuit 105d comprises a series connection of a switch S9 and a switch S10, being configured to switch during a positive half-cycle of the input phase voltage Vᵢ(t). The switching circuit 105d further comprises a series connection of a switch S11 and a switch S12, being configured to switch during a negative half-cycle of the input phase voltage Vᵢ(t).

The construction of the additional commutation paths for the power converter 100, 200 can be performed through different manners, as depicted in FIGS. 3a to 3d. The option shown in FIG. 3b is attractive, since it requires only one switch. On the other hand, in the variants shown in FIGS. 3a and 3c each of the two switches is commutated during one half-cycle of the grid. The option shown in FIG. 3d uses four switches and can be more efficient due to the possibility of implementing synchronous rectification. The order of the switches can be changed without impact on the functionality.

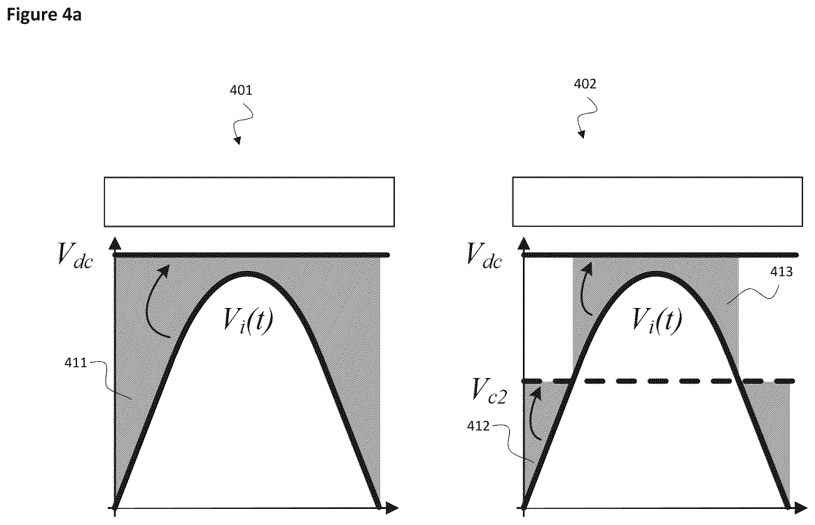

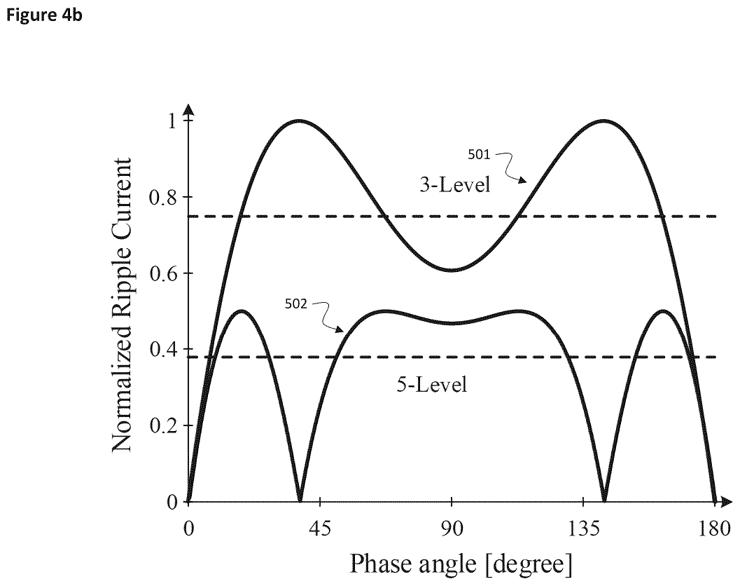

FIG. 4a shows two voltage diagrams 401, 402 illustrating the principle of voltage conversion for a 3-level power converter (left side) and a 5-level power converter 100, 200 according to an embodiment of the disclosure (right side).

When operating with large differences between input and output voltage levels, a significant reduction of conversion efficiency can be observed for almost any topology.

Reason for this is the increasing amount of processed energy that needs to be firstly stored in a passive element before reaching the load. It is therefore possible to say that the higher the amount of such “indirect” energy; the lower will be the converter efficiency. On the other extreme, in case of both input and output voltage values being similar, almost all the energy flows directly to the load, resulting in higher efficiency.

Such situation is especially critical when considering the operation of inverters or controlled rectifiers, as power factor correction (PFC) circuits, because these converters sweep a wide range of duty cycle values. In case of difference between peak AC value and DC value being large, the modulation index will significantly deviate from 1. Consequently, a higher amount of losses can be expected.

The power converter 100, 200 presented above with respect to FIGS. 1a to 3d, that can be operated as a controlled rectifier with two distinct DC-links having different voltage levels, can deal with these drawbacks. Depending on the phase angle of the sine wave, the power converter 100, 200 will select the one out of the available DC-links that best matches the required output voltage levels, thus increasing the converter efficiency as shown in the diagram 402 on the right side of FIG. 4a.

FIG. 4b shows a performance diagram illustrating behavior of the normalized ripple current 501, 502 for a power converter according to a 3-level conversion topology and for the power converter 100, 200 based on a 5-level conversion topology according to an embodiment of the disclosure.

The normalized ripple current for the two topologies shown in FIG. 4a by adopting the same inductance values is illustrated in FIG. 4b. For this reason, the disclosed 5-level topology is able to adopt smaller inductances to achieve similar ripple current levels when compared to 3-level topologies.

Besides the reduction of the required AC filter inductance, the main advantages of a 5-level topology compared to 2 or 3-level circuits are the lower electrical stresses on the semiconductors, the better distribution of losses through the components and lower EMC efforts.

On the other hand, multilevel circuits have higher amount of components. However, it does not mean larger semiconductor chip area, which are related to the amount of losses.

Of course, it can be combined with the increase of the switching frequency in an appropriate manner to optimize the achievements.

Such topology improvement represents a most suitable way to reduce the volume of the magnetics, without the cost of increasing the losses due to the use of very high switching frequencies.

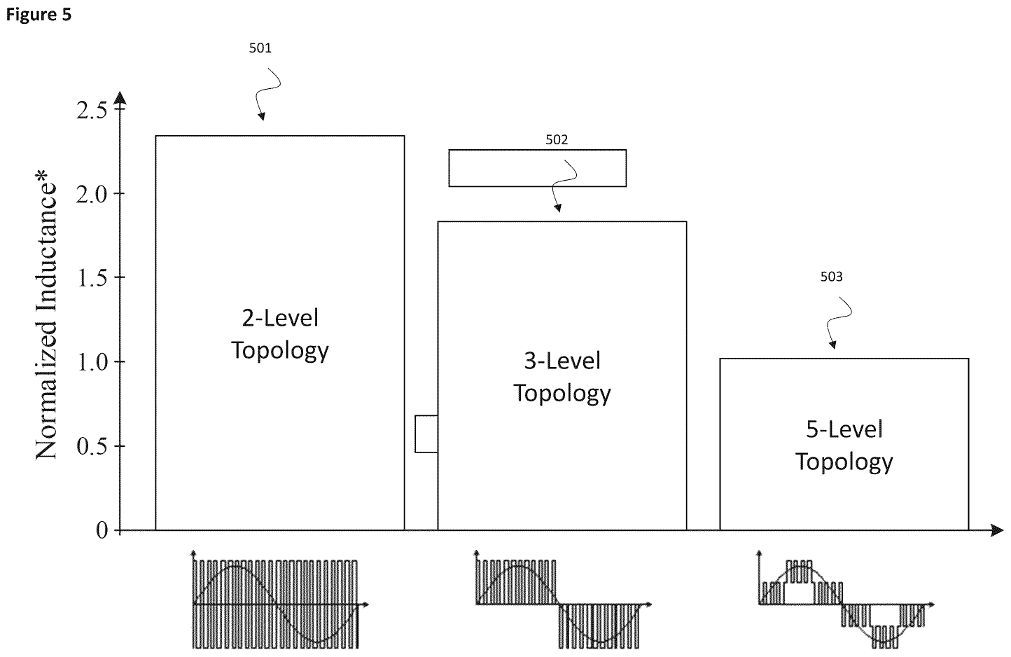

FIG. 5 shows a diagram illustrating the required inductances 501, 502, 503 for topologies with different voltage levels.

A basic comparison between the necessary values of inductance for a given average current for topologies with different voltage levels characteristics is presented in FIG. 5. One can observe the clear advantage of using a power converter 100, 200 according to a 5-level topology in comparison to 2 or even 3-level ones. Apart from that, in the power converter 100, 200 described in this disclosure, the power switches commutate with lower voltage ratings, reducing the switching losses as well as the common-mode filtering efforts.

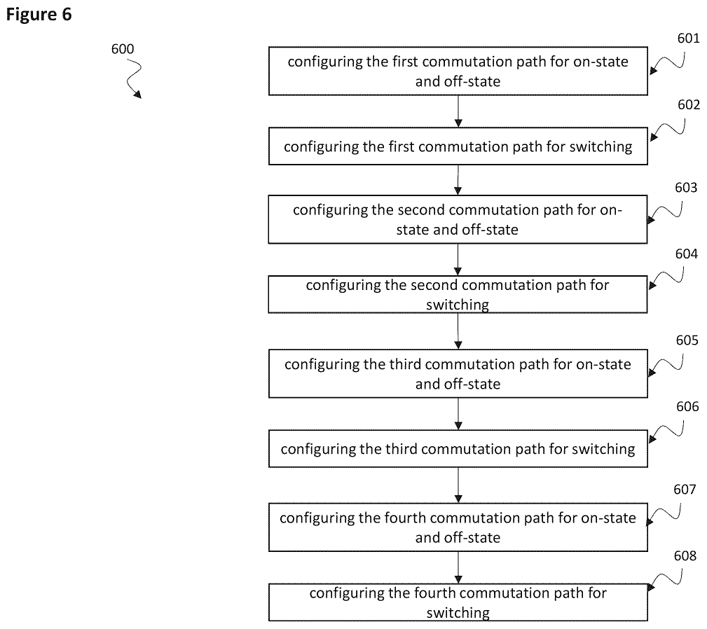

FIG. 6 shows a schematic diagram illustrating a method 600 for configuring a power converter 100, 200 according to an embodiment of the disclosure.

The power converter can be a power converter 100, 200 as described above with respect to FIGS. 1a to 3d.

Such power converter 100, 200 comprises: an alternate current, AC, terminal 101 for providing an input phase voltage Vᵢ(t); a first direct current, DC, terminal 102 for providing a first DC voltage V_{DC} referred to a third DC terminal 104; a second DC terminal 103 for providing a second DC voltage V_{C2} referred to the third DC terminal 104; a first commutation path 110 between the AC terminal 101 and the second DC terminal 103, a second commutation path 120 between the AC terminal 101 and the first DC terminal 102, a third commutation path 130 between the AC terminal 101 and the second DC terminal 103, and a fourth commutation path 140 between the AC terminal 101 and the first DC terminal 102.

The method 600 comprises: configuring 601 the first commutation path 110 for a first on-state 110a and a first off-state 110b, wherein the first commutation path 110 is active during a positive half-cycle of the input phase voltage Vᵢ(t), e.g., as described above with respect to FIGS. 1a to 3d.

The method 600 comprises: configuring 602 the first commutation path 110 to switch between storing energy provided by the AC terminal 101 in a first energy storage L1 during the first on-state 110a and transferring the stored energy to the second DC terminal 103 during the first off-state 110b, e.g., as described above with respect to FIGS. 1a to 3d.

The method 600 comprises: configuring 603 the second commutation path 120 for a second on-state 120a and a second off-state 120b, wherein the second commutation path 120 is active during a positive half-cycle of the input phase voltage Vᵢ(t), e.g., as described above with respect to FIGS. 1a to 3d.

The method 600 comprises: configuring 604 the second commutation path 120 to switch between storing energy provided by the AC terminal 101 in the first energy storage L1, at the same time transferring energy to the second DC terminal 103, during the second on-state 120a and transferring the stored energy to the first DC terminal 102 during the second off-state 120b, e.g., as described above with respect to FIGS. 1a to 3d.

The method 600 comprises: configuring 605 the third commutation path 130 for a third on-state 130a and a third off-state 130b, wherein the third commutation path 130 is active during a negative half-cycle of the input phase voltage Vᵢ(t), e.g., as described above with respect to FIGS. 1a to 3d.

The method 600 comprises: configuring 606 the third commutation path 130 to switch between storing energy provided by the AC terminal 101 in a second energy storage L2 during the third on-state 130a and transferring the stored energy to the second DC terminal 103 during the third off-state 130b, e.g., as described above with respect to FIGS. 1a to 3d.

The method 600 comprises: configuring 607 the fourth commutation path 140 for a fourth on-state 140a and a fourth off-state 140b, wherein the fourth commutation path 140 is active during a negative half-cycle of the input phase voltage Vᵢ(t), e.g., as described above with respect to FIGS. 1a to 3d.

The method 600 comprises: configuring 608 the fourth commutation path 140 to switch between storing energy provided by the AC terminal 101 in a second energy storage L2, at the same time transferring energy to the second DC terminal 103, during the fourth on-state 140a and transferring the stored energy to the first DC terminal 102 during the fourth off-state 140b, e.g., as described above with respect to FIGS. 1a to 3d.

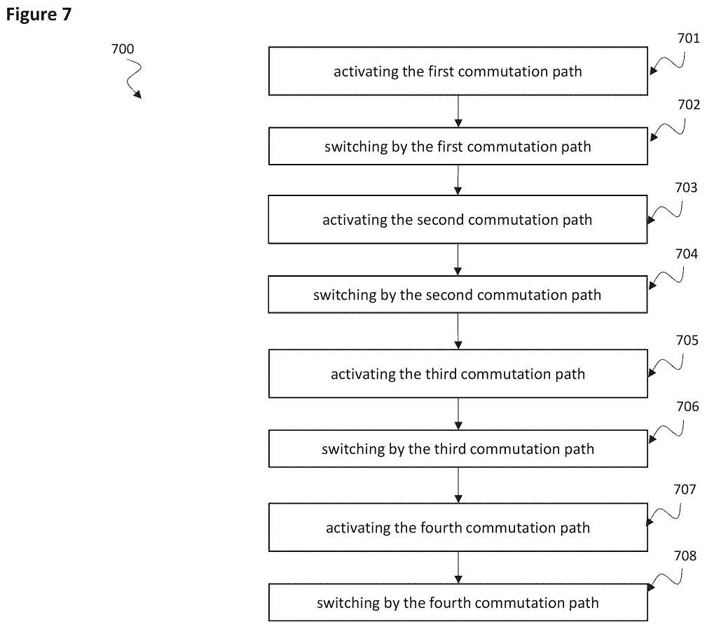

FIG. 7 shows a schematic diagram illustrating a method 700 for operating a power converter 100, 200 according to an embodiment of the disclosure.

The power converter can be a power converter 100, 200 as described above with respect to FIGS. 1a to 3d.

Such power converter 100, 200 comprises: an alternate current, AC, terminal 101 for providing an input phase voltage Vᵢ(t); a first direct current, DC, terminal 102 for providing a first DC voltage V_{DC} referred to a third DC terminal 104; a second DC terminal 103 for providing a second DC voltage V_{c2} referred to the third DC terminal 104; a first commutation path 110 between the AC terminal 101 and the second DC terminal 103, a second commutation path 120 between the AC terminal 101 and the first DC terminal 102, a third commutation path 130 between the AC terminal 101 and the second DC terminal 103, and a fourth commutation path 140 between the AC terminal 101 and the first DC terminal 102.

The method 700 comprises: activating 701 the first commutation path 110 during a positive half-cycle of the input phase voltage Vᵢ(t), e.g., as described above with respect to FIGS. 1a to 3d.

The method 700 comprises: switching 702, by the first commutation path 110, between storing energy provided by the AC terminal 101 in a first energy storage L1 during the first on-state 110a and transferring the stored energy to the second DC terminal 103 during the first off-state 110b, e.g., as described above with respect to FIGS. 1a to 3d.

The method 700 comprises: activating 703 the second commutation path 120 during a positive half-cycle of the input phase voltage Vᵢ(t), e.g., as described above with respect to FIGS. 1a to 3d.

The method 700 comprises: switching 704, by the second commutation path 120, between storing energy provided by the AC terminal 101 in the first energy storage L1, at the same time transferring energy to the second DC terminal 103, during the second on-state 120a and transferring the stored energy to the first DC terminal 102 during the second off-state 120b, e.g., as described above with respect to FIGS. 1a to 3d.

The method 700 comprises: activating 705 the third commutation path 130 during a negative half-cycle of the input phase voltage Vᵢ(t), e.g., as described above with respect to FIGS. 1a to 3d.

The method 700 comprises: switching 706, by the third commutation path 130, between storing energy provided by the AC terminal 101 in a second energy storage L2 during the third on-state 130a and transferring the stored energy to the second DC terminal 103 during the third off-state 130b, e.g., as described above with respect to FIGS. 1a to 3d.

The method 700 comprises: activating 707 the fourth commutation path 140 during a negative half-cycle of the input phase voltage Vᵢ(t), e.g., as described above with respect to FIGS. 1a to 3d.

The method 700 comprises: switching 708, by the fourth commutation path 140, between storing energy provided by the AC terminal 101 in a second energy storage L2, at the same time transferring energy to the second DC terminal 103, during the fourth on-state 140a and transferring the stored energy to the first DC terminal 102 during the fourth off-state 140b, e.g., as described above with respect to FIGS. 1a to 3d.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present disclosure has been described with reference to one or more particular embodiments, those skilled in the art recognize that many changes may be made thereto without departing from the scope of the present disclosure. It is therefore to be understood that within the scope of the appended claims and their equivalents, the invention may be practiced otherwise than as specifically described herein.

What is claimed is:

1. A power converter, comprising:
an alternate current (AC) terminal for providing an input phase voltage;
a first direct current (DC) terminal for providing a first DC voltage with reference to a third DC terminal;
a second DC terminal for providing a second DC voltage with reference to the third DC terminal;
a first commutation path between the AC terminal and the second DC terminal, the first commutation path configured for a first on-state and a first off-state, wherein the first commutation path is active during a positive half-cycle of the input phase voltage and configured to switch between storing energy provided by the AC terminal in a first energy storage during the first on-state and transferring the stored energy to the second DC terminal during the first off-state;
a second commutation path between the AC terminal and the first DC terminal, the second commutation path configured for a second on-state and a second off-state, wherein the second commutation path is active during a positive half-cycle of the input phase voltage and configured to switch between storing energy provided by the AC terminal in the first energy storage, at the same time transferring energy to the second DC terminal, during the second on-state and transferring the stored energy to the first DC terminal during the second off-state;
a third commutation path between the AC terminal and the second DC terminal, the third commutation path configured for a third on-state and a third off-state, wherein the third commutation path is active during a negative half-cycle of the input phase voltage and configured to switch between storing energy provided by the AC terminal in a second energy storage during the third on-state and transferring the stored energy to the second DC terminal during the third off-state; and
a fourth commutation path between the AC terminal and the first DC terminal, the fourth commutation path configured for a fourth on-state and a fourth off-state, wherein the fourth commutation path is active during a negative half-cycle of the input phase voltage and configured to switch between storing energy provided by the AC terminal in a second energy storage, at the same time transferring energy to the second DC terminal, during the fourth on-state and transferring the stored energy to the first DC terminal during the fourth off-state.

2. The power converter of claim 1,
wherein the first DC terminal and the second DC terminal are coupled via, respectively, a first capacitor and a second capacitor to the third DC terminal.

3. The power converter of claim 1,
wherein the first DC terminal is coupled via a first capacitor to the second DC terminal and the second DC terminal is coupled via a second capacitor to the third DC terminal.

4. The power converter of claim 1,
wherein the power converter is configured for a first operation mode or a second operation mode according to the input phase voltage and the second DC voltage.

5. The power converter of claim 4,
wherein in the first operation mode, the input phase voltage is lower than or equal to the second DC voltage and in the second operation mode, the input phase voltage is higher than the second DC voltage.

6. The power converter of claim 4, comprising:
a switching circuit comprising a series connection of a diode D9 and a switch S10 coupled between a first internal node and the second DC terminal;
a switch S2 coupled between the first internal node and the third DC terminal;
a diode D6 coupled between the third DC terminal and a fourth internal node, the diode D6 forming a return path for both, the first on-state and the first off-state of the first commutation path,
wherein in the first operation mode, the first commutation path is activated during the positive half-cycle of the input phase voltage, wherein the switch S10 of the switching circuit is configured to be permanently closed during the first operation mode and the switch S2 is configured to be closed during the first on-state of the first commutation path, storing the energy provided by the AC terminal in the first energy storage, and to be opened during the first off-state of the first commutation path, transferring the stored energy to the second DC terminal through a freewheeling path composed by the series connection of the diode D9 and the switch S10 of the switching circuit.

7. The power converter of claim 5, comprising:
a switching circuit comprising a series connection of a diode D9 and a switch S10 coupled between a first internal node and the second DC terminal;
a switch S2 coupled between the first internal node and the third DC terminal;
a diode D6 coupled between the third DC terminal and a fourth internal node, the diode D6 forming a return path for both, the first on-state and the first off-state of the first commutation path,
wherein in the first operation mode, the first commutation path is activated during the positive half-cycle of the input phase voltage, wherein the switch S10 of the switching circuit is configured to be permanently closed during the first operation mode and the switch S2 is configured to be closed during the first on-state of the first commutation path, storing the energy provided by the AC terminal in the first energy storage, and to be opened during the first off-state of the first commutation path, transferring the stored energy to the second DC terminal through a freewheeling path composed by the series connection of the diode D9 and the switch S10 of the switching circuit.

8. The power converter of claim 6, further comprising:
a freewheeling diode D1 coupled between the first internal node and the first DC terminal,
wherein in the second operation mode, the second commutation path is activated during the positive half-cycle of the input phase voltage, wherein the switch S2 is configured to be permanently opened during the second operation mode and the switch S10 is configured to be closed during the second on-state of the second commutation path, storing the energy provided by the AC terminal in the first energy storage and transferring energy to the second DC terminal, and to be opened during the second off-state of the second commutation path, transferring the stored energy to the first DC terminal through the freewheeling diode D1, and the diode D6 forming the return path for both the second on-state and the second off-state of the second commutation path.

9. The power converter of claim 7, further comprising:
a freewheeling diode D1 coupled between the first internal node and the first DC terminal,
wherein in the second operation mode, the second commutation path is activated during the positive half-cycle of the input phase voltage, wherein the switch S2 is configured to be permanently opened during the second operation mode and the switch S10 is configured to be closed during the second on-state of the second commutation path, storing the energy provided by the AC terminal in the first energy storage and transferring energy to the second DC terminal, and to be opened during the second off-state of the second commutation path, transferring the stored energy to the first DC terminal through the freewheeling diode D1, and the diode D6 forming the return path for both the second on-state and the second off-state of the second commutation path.

10. The power converter of claim 8, comprising:
a switch S4 coupled between the third DC terminal and a second internal node;
the switching circuit comprising a series connection of a diode D11 and a switch S12 between the second internal node and the second DC terminal;
a diode D8 coupled between the third DC terminal and a third internal node, the diode D8 forming a return path for both the third on-state and the third off-state of the third commutation path,
wherein in the first operation mode, the third commutation path is activated during the negative half-cycle of the input phase voltage, wherein the switch S12 of the switching circuit is configured to be permanently closed during the first operation mode and the switch S4 is configured to be closed during the third on-state of the third commutation path, storing the energy provided by the AC terminal in the second energy storage, and to be opened during the third off-state of the third commutation path, transferring the stored energy to the second DC terminal through a freewheeling path composed by the series connection of the diode D11 and the switch S12 of the switching circuit.

11. The power converter of claim 9, comprising:
a switch S4 coupled between the third DC terminal and a second internal node;
the switching circuit comprising a series connection of a diode D11 and a switch S12 between the second internal node and the second DC terminal;
a diode D8 coupled between the third DC terminal and a third internal node, the diode D8 forming a return path for both the third on-state and the third off-state of the third commutation path,
wherein in the first operation mode, the third commutation path is activated during the negative half-cycle of the input phase voltage, wherein the switch S12 of the switching circuit is configured to be permanently closed during the first operation mode and the switch S4 is configured to be closed during the third on-state of the third commutation path, storing the energy provided by the AC terminal in the second energy storage, and to be opened during the third off-state of the third commutation path, transferring the stored energy to the second DC terminal through a freewheeling path composed by the series connection of the diode D11 and the switch S12 of the switching circuit.

12. The power converter of claim 10, comprising:
a freewheeling diode D3 coupled between the second internal node and the first DC terminal,
wherein in the second operation mode, the fourth commutation path is activated during the negative half-cycle of the input phase voltage, wherein the switch S4 is configured to be permanently opened during the second operation mode and the switch S12 is configured to be closed during the fourth on-state of the fourth commutation path, storing the energy provided by the AC terminal in the second energy storage and transferring energy to the second DC terminal, and to be opened during the fourth off-state of the fourth commutation path, transferring the stored energy to the first DC terminal through the freewheeling diode D3, wherein the diode D8 forms a return path for both the fourth on-state and the fourth off-state of the fourth commutation path.

13. The power converter of claim 1,
wherein the power converter comprises a switching circuit that comprises a series connection of a diode D9 and a switch S10, being configured to switch during a positive half-cycle of the input phase voltage; and
wherein the switching circuit comprises a series connection of a diode D11 and a switch S12, being configured to switch during a negative half-cycle of the input phase voltage.

14. The power converter of claim 1,
wherein the power converter comprises a switching circuit that comprises a series connection of a diode D9 and a switch S10, being configured to switch during a positive half-cycle of the input phase voltage; and
wherein the switching circuit comprises a series connection of a diode D11 and a switch S10, being configured to switch during a negative half-cycle of the input phase voltage.

15. The power converter of claim 1,
wherein the power converter comprises a switching circuit that comprises a series connection of a switch S9 and a diode D10, being configured to switch during a positive half-cycle of the input phase voltage; and
wherein the switching circuit comprises a series connection of a switch S11 and a diode D12, being configured to switch during a negative half-cycle of the input phase voltage.

16. The power converter of claim 1,
wherein the power converter comprises a switching circuit that comprises a series connection of a switch S9 and a switch S10, being configured to switch during a positive half-cycle of the input phase voltage; and
wherein the switching circuit comprises a series connection of a switch S11 and a switch S12, being configured to switch during a negative half-cycle of the input phase voltage.

17. The power converter of claim 1,
wherein the first energy storage comprises a first inductor; and
wherein the second energy storage comprises a second inductor.

18. The power converter of claim 17,
wherein the first inductor comprises a first coupling inductor and a second coupling inductor, and wherein the second inductor comprises a third coupling inductor and a fourth coupling inductor, the first coupling inductor being coupled to the third coupling inductor via a first magnetic coupling device and the second coupling inductor being coupled to the fourth coupling inductor via a second magnetic coupling device.

19. A method for configuring a power converter, wherein the power converter comprises: an alternate current (AC) terminal for providing an input phase voltage; a first direct current (DC) terminal for providing a first DC voltage with reference to a third DC terminal; a second DC terminal for providing a second DC voltage with reference to the third DC terminal; a first commutation path between the AC terminal and the second DC terminal, a second commutation path between the AC terminal and the first DC terminal, a third commutation path between the AC terminal and the second DC terminal, and a fourth commutation path between the AC terminal and the first DC terminal,
wherein the method comprises:
configuring the first commutation path for a first on-state and a first off-state, wherein the first commutation path is active during a positive half-cycle of the input phase voltage;
configuring the first commutation path to switch between storing energy provided by the AC terminal in a first energy storage during the first on-state and transferring the stored energy to the second DC terminal during the first off-state;
configuring the second commutation path for a second on-state and a second off-state, wherein the second commutation path is active during a positive half-cycle of the input phase voltage;
configuring the second commutation path to switch between storing energy provided by the AC terminal in the first energy storage, at the same time transferring energy to the second DC terminal, during the second on-state and transferring the stored energy to the first DC terminal during the second off-state;
configuring the third commutation path for a third on-state and a third off-state, wherein the third commutation path is active during a negative half-cycle of the input phase voltage;
configuring the third commutation path to switch between storing energy provided by the AC terminal in a second energy storage during the third on-state and transferring the stored energy to the second DC terminal during the third off-state;
configuring the fourth commutation path for a fourth on-state and a fourth off-state, wherein the fourth commutation path is active during a negative half-cycle of the input phase voltage; and
configuring the fourth commutation path to switch between storing energy provided by the AC terminal in a second energy storage, at the same time transferring energy to the second DC terminal, during the fourth on-state and transferring the stored energy to the first DC terminal during the fourth off-state.

20. A method for operating a power converter, wherein the power converter comprises: an alternate current (AC) terminal for providing an input phase voltage; a first direct current (DC) terminal for providing a first DC voltage with reference to a third DC terminal; a second DC terminal for providing a second DC voltage with reference to the third DC terminal; a first commutation path between the AC terminal and the second DC terminal, the first commutation path configured for a first on-state and a first off-state, a second commutation path between the AC terminal and the first DC terminal, the second commutation path configured for a second on-state and a second off-state, a third commutation path between the AC terminal and the second DC terminal, the third commutation path configured for a third on-state and a third off-state, and a fourth commutation path between the AC terminal and the first DC terminal, the fourth commutation path configured for a fourth on-state and a fourth off-state, wherein the method comprises:
activating the first commutation path during a positive half-cycle of the input phase voltage;
switching, by the first commutation path, between storing energy provided by the AC terminal in a first energy storage during the first on-state and transferring the stored energy to the second DC terminal during the first off-state;
activating the second commutation path during a positive half-cycle of the input phase voltage;
switching, by the second commutation path, between storing energy provided by the AC terminal in the first energy storage, at the same time transferring energy to the second DC terminal, during the second on-state and transferring the stored energy to the first DC terminal during the second off-state;
activating the third commutation path during a negative half-cycle of the input phase voltage;
switching, by the third commutation path, between storing energy provided by the AC terminal in a second energy storage during the third on-state and transferring the stored energy to the second DC terminal during the third off-state;
activating the fourth commutation path during a negative half-cycle of the input phase voltage; and
switching, by the fourth commutation path, between storing energy provided by the AC terminal in a second energy storage, at the same time transferring energy to the second DC terminal, during the fourth on-state and transferring the stored energy to the first DC terminal during the fourth off-state.
